(19) United States
(12) Patent Application Publication
(10) Pub. No.: US 2025/0222735 A1
(43) Pub. Date: Jul. 10, 2025

(54) CONTROL SYSTEM AND METHOD FOR VEHICLE SUSPENSION

(71) Applicant: JAGUAR LAND ROVER LIMITED, Whitley, Coventry, Warwickshire (GB)

(72) Inventors: Nipun PAYAGALAGE-DON, Whitley, Coventry, Warwickshire (GB); James ROBERTSON, Whitley, Coventry, Warwickshire (GB); Robert NEILSON, Whitley, Coventry, Warwickshire (GB)

(21) Appl. No.: 18/701,893

(22) PCT Filed: Oct. 21, 2021
(86) PCT No.: PCT/EP2021/079191

§ 371 Date: Apr. 16, 2024

(51) Int. Cl. B60G 17/0195; B60G 17/018

(52) U.S. Cl. CPC B60G 17/0195; B60G 17/018; B60G 2400/823; B60G 2500/10; B60G 2800/91

(57) ABSTRACT

A control system for a vehicle, comprising one or more controllers, configured to receive a collision warning signal, and modify one or more parameters of the vehicle suspension system in response to the received collision warning signal. In this way, the suspension may be automatically configured in a manner which assists the driver in carrying out a vehicle manoeuvre to avoid a potential collision.

### TECHNICAL FIELD

The present disclosure relates to a control system and method for vehicle suspension. Aspects of the invention relate to a control system, a method of controlling vehicle suspension, a computer program and a vehicle. Embodiments of the present disclosure relate to control of a vehicle suspension system in response to a collision warning signal.

### BACKGROUND

It is known to provide vehicles with adjustable suspension. The adjustable suspension may be semi active or fully active, taking into account information from vehicle systems and/or external sensors to continuously adjust the suspension settings to cater for road surfaces and terrain features as they are traversed. The suspension settings being varied may be physical parameters such as damper rate and spring stiffness. However, there is an inherent compromise in any passenger road vehicle's suspension system, between its ability to isolate the occupants of the vehicle from vibrations from the road and its ability to suppress primary body motion under acceleration and deceleration.

This results in scenarios in which the vehicle suspension settings may be suboptimal for a particular driving situation.

It is an aim of the present invention to address one or more of the disadvantages associated with the prior art.

### SUMMARY OF THE INVENTION

Aspects and embodiments of the invention provide a control system, a method of controlling vehicle suspension, a computer program and a vehicle, as claimed in the appended claims

According to an aspect of the present invention there is provided a control system for a vehicle having a suspension system, the control system comprising one or more controllers, the control system configured to:
receive a collision warning signal; and
modify one or more parameters of the vehicle suspension system in response to the received collision warning signal.

In this way, the suspension may be automatically configured in a manner which assists the driver in carrying out a vehicle manoeuvre to avoid a potential collision.

The one or more controllers may collectively comprise:
at least one electronic processor having an electrical input for receiving the collision warning signal; and
at least one memory device electrically coupled to the at least one electronic processor and having instructions stored therein;
and wherein the at least one electronic processor is configured to access the at least one memory device and execute the instructions thereon so as to modify the one or more parameters of the vehicle suspension system.

The one or more parameters of the vehicle suspension are preferably modified to increase primary body control (under evasive manoeuvres).

More specifically, the one or more parameters may be modified to one or more of:
(a) increase stiffness of the vehicle suspension;
(b) increase a level of damping provided by the vehicle suspension; and
(c) increase a level of roll compensation provided by the vehicle suspension.

In practice, increasing the stiffness and damping levels may increase the level of roll compensation provided, but in some cases further measures may be taken to more directly influence roll compensation, such as by adjusting a stiffness parameter of an active roll bar system (to increase stiffness thereof) in the case that the vehicle is equipped with this feature.

Each of these changes may serve to improve vehicle control while a driver is carrying out evasive manoeuvres to avoid a potential collision.

The vehicle suspension may be configurable into a user selectable driving mode (such as a sports mode, or dynamic mode, in which the vehicle has a more sporty feel to drive, and improved performance driving characteristics (generally at the expense of comfort and refinement)), and the modification of the one or more parameters may be carried out by automatically configuring the vehicle suspension into the driving mode. That is, rather than modifying the parameters of the suspension system specifically (and only) for the purpose of aiding collision avoidance, the technique may utilise suspension settings already available and associated with a particular driving mode of the vehicle.

The method may comprise reverting the one or more parameters to their previous settings in response to a trigger. The trigger may be the satisfaction of a predetermined condition. For example, the trigger may optionally comprise one or more of an expiry of a time period, a detected collision, the vehicle becoming stationary, the absence of a vehicle evasive manoeuvre, and the completion of a vehicle evasive manoeuvre. In this way, the suspension settings are returned to “normal” when the risk of collision is considered to have passed, thereby returning the driving experience of the driver and passengers to a more refined state.

The absence or completion of the vehicle evasive manoeuvre may be determined in dependence on one or more of vehicle lateral and/or longitudinal acceleration, vehicle yaw rate, vehicle roll rate, vehicle speed and driver inputs.

The collision warning signal may be received from a forward collision warning system (CWS) of the vehicle. Such a collision warning signal may be used elsewhere, such as in generating an alert to the driver (visually or audibly) to make them aware of a collision risk. The collision warning system may use forward looking sensors (for example cameras, radar, lidar or ultrasound) to determine if the vehicle is likely to have a collision with a vehicle or obstacle ahead.

According to another aspect, there is provided a method for controlling vehicle suspension, the method comprising:
receiving a collision warning signal; and
modifying one or more parameters of the vehicle suspension system in response to the received collision warning signal.

The modification of the one or more parameters of the vehicle suspension system may occur after a calibratable delay period, the delay period being calibrated in dependence on one or more of a steering input angle, a current vehicle speed, vehicle lateral and/or longitudinal acceleration and elapsed time since the collision warning signal is generated.

According to another aspect, there is provided a vehicle comprising the control system as described above.

The vehicle may comprise one or more external sensors for sensing objects ahead of the vehicle, and the control system may be configured to identify a potential collision based on the output of the one or more external sensors, and to generate the collision warning signal when a potential collision is identified.

The one or more controllers comprise a first controller for generating the collision warning signal, a second controller for receiving the collision warning signal and responsive to the receipt of the collision warning signal generating a suspension modification request to modify the one or more parameters of the vehicle suspension system, and a third controller for receiving the suspension modification request and responsive to the suspension modification request to modify the one or more parameters of the vehicle suspension system.

The third controller may be configured to select between a plurality of predetermined suspension settings in order to modify the one or more parameters.

The vehicle may further comprise one or more additional vehicle systems responsive to the collision warning signal, the first, second and third controllers and the additional vehicle systems being connected via a network, the first controller being configured to publish the collision warning signal on the network for reception by the second controller and the additional vehicle systems.

According to another aspect, there is provided computer software that, when executed, is arranged to perform the above method.

According to another aspect, there is provided a non-transitory, computer-readable storage medium storing instructions thereon that, when executed by one or more electronic processors, causes the one or more electronic processors to carry out the above method.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a schematic representation of a vehicle having an adaptive suspension system and a vehicle controller;

FIG. 2 shows a control system for implementing the present technique;

FIG. 3 shows the use of the technique to assist with an evasive manoeuvre to avoid a collision; and

FIG. 4 shows a schematic flow diagram of the control method.

### DETAILED DESCRIPTION

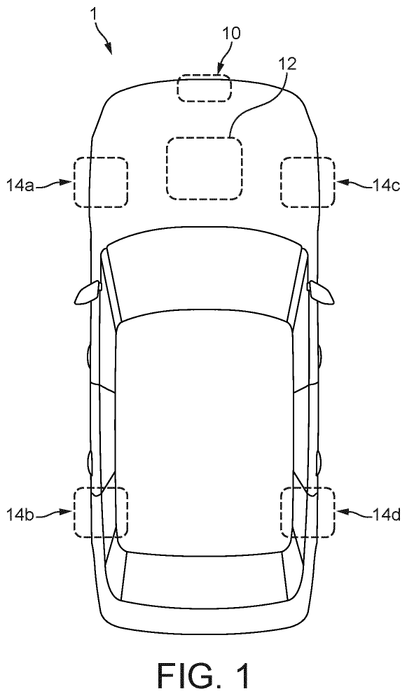

A vehicle 1 in accordance with an embodiment of the present invention is described herein with reference to the accompanying FIG. 1.

With reference to FIG. 1, the vehicle 1 comprises a forward-looking sensor 10, which may for example be an imaging device such as a camera, radar, lidar or any other sensor capable of detecting the presence of objects (including vehicles) ahead of the vehicle 1. It should be understood that the position of the sensor is not constrained to this particular location (for example a camera located in windscreen), and in alternative embodiments other locations and sensor types could be used, including a combination of sensors. The vehicle 1 also comprises a control system 12 (which itself comprises one, or generally many, controllers for carrying out various vehicle functions, as will be explained below) which is connected (wirelessly or wired) to the forward-looking sensor 10. The vehicle 1 also comprises four suspension assemblies (springs and dampers) 14a, 14b, 14c, 14d each providing a respective wheel of the vehicle 1 with an active or semi-active suspension capability. A passive mechanical element to the suspension capability may also be provided by the suspension assemblies. The four suspension assemblies 14a, 14b, 14c, 14d are controlled by the control system 12, generally by adjusting a damping current and/or air spring volume of the dampers and springs to increase or decrease an amount of damping, and increase or decrease the stiffness of the springs. By adjusting these parameters of the suspension assemblies—individually or as a group—it is possible to both generally influence the handling and refinement of the vehicle 1, and also dynamically adapt the suspension system to cope with road surface features such as bumps to improve refinement for the occupants of the vehicle 1.

The present technique influences the existing suspension control system to increase the stiffness and/or damping (increased spring rate and/or increased damping rate) provided by the suspension system (front and/or rear), thereby improving stability during evasive manoeuvres. By increasing stiffness and damping, a degree of roll compensation is also afforded to the vehicle, again contributing to the stability of the vehicle during manoeuvres. In the case of a vehicle having active roll bars, the present technique may also trigger the active roll bars to be stiffened, providing significantly greater roll compensation.

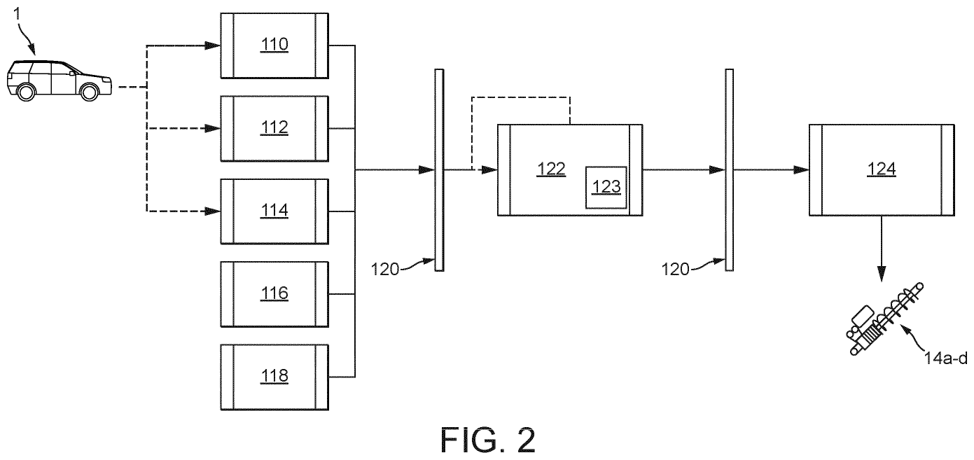

An example control system (such as the vehicle controller 12 of FIG. 1) in accordance with an embodiment of the present invention is described herein with reference to the accompanying FIG. 2. Generally, vehicle controller systems are of a modular nature, both structurally and functionally. Here, the control system 12 comprises an anti-lock braking system (ABS) 110, a Restraints Control Module (RCM) system 112, which controls airbag and belt pretensioner fire times, a steering angle sensor module (SASM) system 114, a gateway module (GWM) 116 and a car configuration file (CCF) 118. The GWM routes network signals/packets between different networks as well as hosting terrain response functionality and the CCF system. These systems are able to output data or parameters which are (or may be) used in the present technique. These systems are connected via a network 120 to a driver assistance domain controller (DADC) 122. This is a centralised processing hub that takes inputs about the vehicle surroundings from a set of sensors, cameras and vehicle network data. This information is processed to provide driver assistance features through arbitrating requests to command vehicle actuators. The DADC 122 is connected via the network 120 to a suspension control function 124 hosted on an Integrated Suspension Control System (ISCS) which is responsible for real time control of active and semi-active suspension hardware. It will be appreciated that, in an alternative implementation, all of the functionality of the present technique could be held on a single electronic controller. The suspension control function 124 provides active suspension control for the vehicle 1 by continuously adjusting control parameters (for example spring rate and damping rate) of the suspension assemblies 14a, 14b, 14c, 14d. In particular, control currents for the dampers and the air spring volumes of the suspension assemblies 14a, 14b, 14c, 14d are individually and dynamically controlled by the suspension control function 124.

In the present embodiment, the ABS 110 outputs, onto the network 120, a vehicle overground speed. The RCM 112 outputs, onto the network 120, vehicle lateral acceleration, vehicle longitudinal acceleration, yaw rate and roll rate. The SASM 114 outputs, onto the network 120, a steering angle for the vehicle 1. The GWM outputs, onto the network 120, a current terrain mode for the vehicle 1 (which may be automatically set, or manually set by the driver). The CCF 118 outputs, onto the network 120, one or more CCF values. The CCF 118 comprises a list of configurable parameters hosted on the Gateway Module (GWM) 116, and communicates to all of the other ECUs (controllers) on the vehicle 1 which features should be present. That is, the CCF 118 is a list of switches to tell the vehicle 1 (or more specifically its controllers) which features should be active. It will be appreciated that the source of each of the input signals for the present technique, such as vehicle speed from ABS, may be different for alternative implementations, for example being received from a different module.

The DADC 122 provides a pre-emptive suspension function, and also provides a forward collision alert warning function. The latter is hosted and read internally on the DADC 122, as a collision warning signal. The DADC 122 is able to make suspension modification requests to the suspension control function 124 when the collision warning signal is generated.

The control system 12 may be considered to comprise a plurality of controllers 110, 112, 114, 122, 124 and is configured to respond to a collision warning signal (which may be generated by one of the controllers, in this case by the controller 122), to modify one or more parameters of the vehicle suspension system in response to the received collision warning signal. In an alternative arrangement a single controller may be provided to implement all functionality.

It is to be understood that the or each controller within the control system 12 can comprise a control unit or computational device having one or more electronic processors (e.g., a microprocessor, a microcontroller, an application specific integrated circuit (ASIC), etc.), and may comprise a single control unit or computational device, or alternatively different functions of the or each controller in the control system 12 may be embodied in, or hosted in, different control units or computational devices. As used herein, the term “controller,” “control unit,” or “computational device” will be understood to include a single controller, control unit, or computational device, and a plurality of controllers, control units, or computational devices collectively operating to provide the required control functionality. A set of instructions could be provided which, when executed, cause the controller to implement the control techniques described herein (including some or all of the functionality required for the method described herein). The set of instructions could be embedded in said one or more electronic processors of the controller; or alternatively, the set of instructions could be provided as software to be executed in the controller. A first controller or control unit may be implemented in software run on one or more processors. One or more other controllers or control units may be implemented in software run on one or more processors, optionally the same one or more processors as the first controller or control unit. Other arrangements are also useful.

In the example illustrated in FIG. 2, each of the controllers 110, 112, 114, 122, 124 comprises at least one electronic processor having one or more electrical input(s) for receiving one or more input signal (from one or more of the other controllers), and one or more electrical output(s) for outputting one or more output signal(s) (to one or more of the other controllers). As mentioned, the input and output signals may be communicated via the network 120. That is, in FIG. 2 the various controllers are electronically coupled together via the network 120. The or each controller may further comprise at least one memory device electrically coupled to the at least one electronic processor and having instructions stored therein. This is shown for the controller 122, which can be seen to comprise a memory 123. The at least one electronic processor 122 is configured to access the at least one memory device 123 and execute the instructions thereon so as to modify the one or more parameters of the vehicle suspension system in dependence on a detected collision warning flag.

The, or each, electronic processor may comprise any suitable electronic processor (e.g., a microprocessor, a microcontroller, an ASIC, etc.) that is configured to execute electronic instructions. The, or each, electronic memory device 123 may comprise any suitable memory device and may store a variety of data, information, threshold value(s), lookup tables or other data structures, and/or instructions therein or thereon. In an embodiment, the memory device 123 has information and instructions for software, firmware, programs, algorithms, scripts, applications, etc. stored therein or thereon that may govern all or part of the methodology described herein. The processor, or each, electronic processor may access the memory device 123 and execute and/or use that or those instructions and information to carry out or perform some or all of the functionality and methodology described herein.

The at least one memory device 123 may comprise a computer-readable storage medium (e.g. a non-transitory or non-transient storage medium) that may comprise any mechanism for storing information in a form readable by a machine or electronic processors/computational devices, including, without limitation: a magnetic storage medium (e.g. floppy diskette); optical storage medium (e.g. CD-ROM); magneto optical storage medium; read only memory (ROM); random access memory (RAM); erasable programmable memory (e.g. EPROM ad EEPROM); flash memory; or electrical or other types of medium for storing such information/instructions.

An example controller 122 has been described comprising at least one electronic processor configured to execute electronic instructions stored within at least one memory device 123, which when executed causes the electronic processor(s) to carry out the method as hereinbefore described. A similar structure may be provided for each of the controllers 110, 112, 114 and 124. However, it will be appreciated that embodiments of the present invention can be realised in any suitable form of hardware, software or a combination of hardware and software. For example, it is contemplated that the present invention is not limited to being implemented by way of programmable processing devices, and that at least some of, and in some embodiments all of, the functionality and or method steps of the present invention may equally be implemented by way of non-programmable hardware, such as by way of non-programmable ASIC, Boolean logic circuitry, etc.

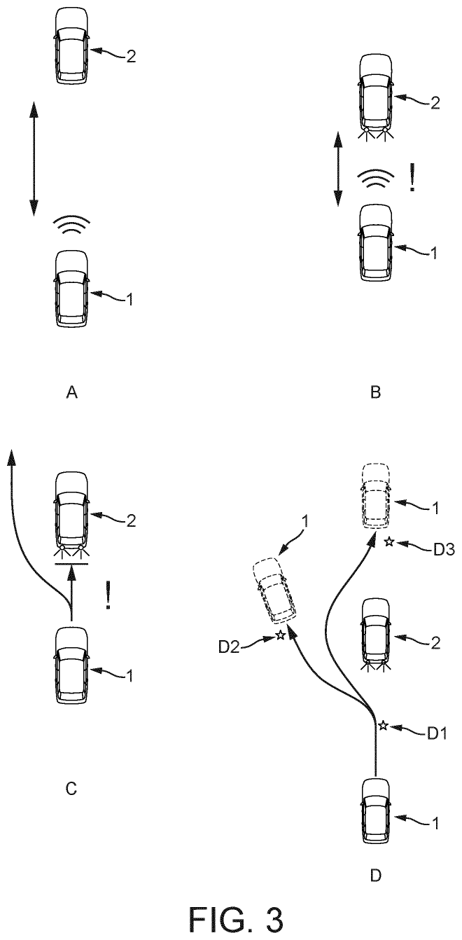

An example use case for the present technique in accordance with an embodiment of the present invention is described herein with reference to the accompanying FIG. 3. Four stages of the use case are shown with respect to time, these progressing from a stage A to a stage D.

In stage A, the forward collision warning system of the vehicle 1 monitors obstacles ahead of the vehicle 1 using mid-range radar (MRR) and a forward looking camera. In Stage A, a second vehicle 2 is sufficiently far ahead of the vehicle 1 that no collision warning signal is generated, and so no action is taken to modify the suspension system.

In stage B, the second vehicle 2 is sufficiently close to the vehicle 1 that the collision warning signal is generated. In particular, when a potential collision is predicted to occur, the forward collision warning system of the vehicle 1 generates an alert flag readable on the network 120 and internally within the DADC 122.

In stage C, when the forward collision warning flag is detected by the collision mitigation assistance (CMA) function of the DADC 122, the CMA function triggers a suspension mode request from ISCS to put the suspension into a dynamic terrain mode condition. The system is preferably configured to change the condition before the driver has a chance to react.

In stage D, the suspension control function changes the suspension settings (mode) upon receipt of the request from the DADC 122. As a result, the suspension system will be in dynamic mode to facilitate evasive manoeuvring at a point D1, in advance of the collision taking place. The suspension system then stays in the dynamic mode until, for example, the vehicle 1 comes to a stop (as shown in FIG. 3 at point D2), or once the vehicle 1 has completed a manoeuvre and resumed normal driving (as shown in FIG. 3 at point D3).

While in FIG. 3 the system detects, and acts on, information regarding a vehicle ahead, it will be appreciated that the same would apply for a detected obstacle ahead of the vehicle.

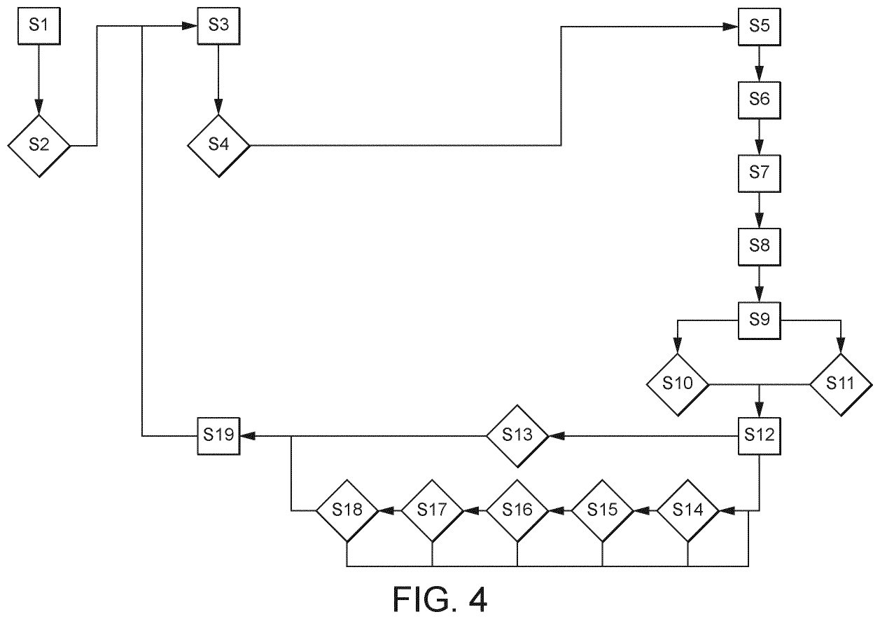

Referring to FIG. 4, an example control method according to one embodiment is illustrated by way of a flow diagram.

At a step S1, a current driving mode is determined. In particular, in some embodiments the collision mitigation assistance method is only applicable in certain driving moves, such as comfort modes or economy driving modes. The collision mitigation assistance method may not apply where the vehicle is already in a dynamic or sports mode (since the suspension settings in this case are already in a suitable state for carrying out an evasive manoeuvre) or when in off-road modes where the suspension settings used to implement collision mitigation assistance may be unsuitable for an off-road driving surface. Based on the present driving mode, it is determined at a step S2 whether the collision mitigation assistance functionality is available. If not, the process of FIG. 4 returns to the step S1, and is on hold until the driving mode changes at the step S1. If the collision mitigation assistance functionality is determined to be available at the step S2, then at a step S3 the road ahead is monitored for collision risks.

At a step S4, it is determined whether a collision risk is detected. If not, then the process returns to the step S3. If a collision risk is detected, then at a step S5 a collision warning flag is generated and published on the network 120. In practice, the steps S3 and S4 are ongoing since the collision warning system not only serves as an input to the present technique, but also as an input to a driver notification system (to warn of a collision risk) and potentially other vehicle functions (such as automatic braking), each of which will utilise the collision warning flag. As such, the steps S3 and S4 are carried out in parallel with the steps S1 and S2, and also with the subsequent steps described below.

At a step S6, the collision warning flag generated at the step S5 is detected by the collision mitigation assistance function hosted on the DADC 122. In response to the collision warning flag being detected, the collision mitigation assistance function requests, at a step S7, after a calibratable delay period, the adaptive suspension controller 124 to adjust the suspension settings, and in particular to set the suspension settings to a sports mode. At a step S8, the adaptive suspension controller 124 adjusts the suspension settings accordingly, in response to the request. It will therefore be appreciated that the step S8 puts the vehicle suspension system into a state in which an evasive manoeuvre can be carried out effectively.

At a step S9, an end condition is monitored for, in order that the vehicle suspension system can revert to normal operation (which can be expected to offer greater comfort and refinement for the driver and passengers) at the earliest suitable time. To determine this, various vehicle parameters (supplied from the systems 110, 112, 114) may be monitored, and several steps carried out. In one implementation, these are:

At step S10, the system monitors the time elapsed after activation of the modified suspension request (at the step S8). If this exceeds a calibratable threshold limit, the system moves to step S12, otherwise the process remains at the step S10.

In parallel to the step S10, the system monitors how long the vehicle has been braking or turning (lateral and/or longitudinal acceleration values are beyond a calibratable threshold limit) as an indication of how long an evasive manoeuvre has been taking place. If this time exceeds a calibratable threshold value, the system moves to step S12, otherwise remains at step S10.

Once the criteria for either step S10 or S11 has been met, the system moves to step S12, signifying the point at which the system will ascertain the conditions for deactivation of the modified suspension behaviour.

At step S13, the system evaluates the time elapsed since step S12 had been achieved. If this exceeds a calibratable threshold value, the system will progress to step S19, at which deactivation criteria for the system are considered to have been met, and the system deactivates the modified suspension behaviour before returning to the step S3. This provides a guaranteed end condition which does not relate to specific vehicle parameters meeting particular requirements.

In parallel to step S13, the system will execute step S14 in which the steering wheel angle is monitored. If this drops below a calibratable threshold value, the system moves to a step S15, otherwise remains at step S14.

At the step S15, the system monitors the measured vehicle yaw rate. If this drops below a calibratable threshold value, the system moves to a step S16, otherwise moves back to the step S14.

At the step S16, the system monitors the measured vehicle lateral acceleration. If this drops below a calibratable threshold value, the system moves to a step S17, otherwise moves back to the step S14.

At the step S17, the system monitors the measured vehicle longitudinal acceleration. If this drops below a calibratable threshold value, the system moves to a step S18, otherwise moves back to the step S14.

Once at step S18, the system monitors the measured vehicle roll rate. If this drops below a calibratable threshold value, the system moves to the step S19, otherwise moves back to step S14.

In this way, the end condition will be met if all of the parameters monitored at the steps S14 to S18 fall below their respective thresholds, indicative that the vehicle is no longer performing an evasive manoeuvre, and thus does not require the adjusted suspension.

In an alternative implementation, the end condition may be assessed differently. For example, the vehicle speed, provided by the ABS 110, may be monitored. If the vehicle speed drops to (or close to) zero, the vehicle is determined to be stationary. This may be because the collision occurred, or because the driver undertook a manoeuvre to bring the vehicle to a standstill to avoid a collision. In either case, once the vehicle is stationary the collision mitigation avoidance function is no longer required. In some implementations the vehicle may not need to be stationary to terminate the collision mitigation avoidance function, but may instead simply be required to drop below a predetermined threshold (which may be static, or defined relative to the vehicle speed at the time at which the collision warning flag was generated). The determination that the vehicle is stationary may be considered an end condition, reverting the process to the step S3.

Alternatively (or additionally), it may be determined whether an evasive manoeuvre has been completed. This can be achieved based on a combination of one or more of the vehicle speed provided by the ABS 110, the vehicle latitudinal and longitudinal accelerations, yaw rate and roll rate provided by the RCM 112 and the steering angle provided by the SASM 114. These parameters may be monitored with respect to time, and particular patterns of parameter changes categorised as relating to a completed manoeuvre. In one simple case, a temporary reduction in vehicle speed, following a reversion to the pre-collision warning flag speed might be taken to indicate that a simple braking manoeuvre has been sufficient to avoid the collision. Similarly, a progression of steering angle, accompanied by related changes is yaw, roll and vehicle acceleration might be taken to indicate that the driver has steered around an obstacle to avoid collision. The determination that an evasive manoeuvre has been completed may be taken as an end condition. Alternatively, or additionally, it may be determined whether an evasive manoeuvre has not been completed, within a predetermined period of time.

Alternatively, or additionally, it may be determined whether a collision has taken place. In a simple case this may be achieved simply by determining that the vehicle has come to a rest. In a more complex case the collision may be detected base on one of more of a vehicle lateral acceleration, longitudinal acceleration, yaw rate or roll rate exceeding a predetermined threshold indicative of a collision.

With the above-described collision mitigation assistance function, in a period leading up to a potential collision with an obstacle ahead of the vehicle, a default suspension set-up which offers a compromise between refinement and handling, and which leads to a sub-optimal condition for the driver to perform an evasive manoeuvre, is switched to a modified suspension setup which favours increased primary body control. In this way, the driver is able to perform an evasive manoeuvre with greater confidence and accuracy.

More specifically, by utilising the vehicle's on-board collision warning system, in the lead up to an identified scenario in which an imminent collision may happen, the collision mitigation assistance function will instruct the vehicle's semi or fully active suspension control system to modify the suspension into a body control biased set-up configuration. The vehicle's suspension will remain in this state until a trigger condition applies, such as an evasive manoeuvre being complete or a pre-determined period of time elapsing.

The system works by initially monitoring the status of the forward collision warning system (FCWS) published on the vehicle's network. If the FCWS indicates that a collision is likely to occur (a single state change published on the vehicle network), the system will request a change to a more dynamic body controlled set-up from the suspension control system (SCS) after an optional calibratable delay period. In some implementations the delay period is calibratable (including permitting it to be set to zero) to provide the system with tuning robustness to mitigate for faulty or inconsistent activation of the forward collision warning system. The delay may be a configurable feature based upon certain input criteria monitored on the vehicle, such as steering input angle, measured vehicle speed, lateral and longitudinal acceleration as well as the elapsed time from the collision warning message being raised. Vehicle states are assessed against threshold configurable parameters.

Once the SCS has altered state, the system continues to monitor vehicle lateral acceleration, longitudinal acceleration, steering wheel inputs and brake inputs for a sign that an evasive manoeuvre has started and been completed, before requesting a switch back to its original state from the SCS. The conditions for de-activation from an activated condition are configurable in the same manner as the activation condition: monitoring of various vehicle states to assess if they have dropped below configurable threshold values. This includes steering angle, yaw rate, roll rate, lateral and longitudinal acceleration as well as elapsed time since first activation. If there are no signs of an evasive manoeuvre being performed and/or a fixed period of time has elapsed, the system will request a return to original state from the SCS by default.

This present technique makes use of existing hardware, software and data provision capabilities to achieve its aim, particularly an existing active suspension system and existing collision warning system. These two systems are conventionally not linked together, but in the present case are linked via the control methodology described above.

It will be appreciated that changing the SCS suspension mode to a more body control biased set-up prior to an evasive manoeuvre being performed by the driver gives them added peace of mind. The vehicle being in a more preferential condition to perform such a manoeuvre will increase the likelihood of being able to complete it successfully and avoid a collision, and thus improve driver (and passenger) safety.

It will be appreciated that various changes and modifications can be made to the present invention without departing from the scope of the present application. For example, all of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A control system for a vehicle having a suspension system, the control system comprising one or more controllers, the control system configured to:
receive a collision warning signal; and
modify one or more parameters of the suspension system in response to the received collision warning signal.

2. The control system of claim 1, wherein the one or more controllers collectively comprise:
at least one electronic processor having an electrical input for receiving the collision warning signal; and
at least one memory device electrically coupled to the at least one electronic processor and having instructions stored therein;
and wherein the at least one electronic processor is configured to access the at least one memory device and execute the instructions thereon so as to modify the one or more parameters of the suspension system.

3. The control system of any claim 1, wherein the one or more parameters of the suspension system are modified to increase primary body control.

4. The control system of claim 1, wherein the one or more parameters are modified to one or more of:
(a) increase stiffness of the suspension system;
(b) increase a level of damping provided by the suspension system; and
(c) increase a level of roll compensation provided by the suspension system.

5. The control system of claim 1, wherein the suspension system is configurable into a user selectable driving mode, and the modification of the one or more parameters is carried out by automatically configuring the suspension system into the user selectable driving mode.

6. The control system of claim 1, comprising reverting the one or more parameters to their previous settings in response to a trigger.

7. The control system of claim 16, wherein the absence or completion of the vehicle evasive manoeuvre is determined in dependence on one or more of vehicle lateral and/or longitudinal acceleration, vehicle yaw rate, vehicle roll rate, vehicle speed and driver inputs.

8. The control system of claim 1, wherein the collision warning signal is received from a forward collision warning system of the vehicle.

9. A method for controlling vehicle suspension, the method comprising:
receiving a collision warning signal; and
modifying one or more parameters of a vehicle suspension system in response to the received collision warning signal.

10. A vehicle comprising the control system of claim 1.

11. The vehicle according to claim 10, the vehicle comprising one or more external sensors for sensing objects ahead of the vehicle, and wherein the control system is configured to identify a potential collision based on an output of the one or more external sensors, and to generate the collision warning signal when the potential collision is identified.

12. The vehicle of claim 10, wherein the one or more controllers comprise a first controller for generating the collision warning signal, a second controller for receiving the collision warning signal and responsive to receipt of the collision warning signal generating a suspension modification request to modify the one or more parameters of the suspension system, and a third controller for receiving the suspension modification request and responsive to the suspension modification request to modify the one or more parameters of the suspension system.

13. The vehicle of claim 12, wherein the third controller is configured to select between a plurality of predetermined suspension settings.

14. Computer software that, when executed, is arranged to perform the method according to claim 9.

15. A non-transitory, computer-readable storage medium storing instructions thereon that, when executed by one or more electronic processors, causes the one or more electronic processors to carry out the method of claim 9.

16. The control system of claim 6, the trigger comprising one or more of an expiry of a time period, a detected collision, the vehicle becoming stationary, the absence of a vehicle evasive manoeuvre, and completion of a vehicle evasive manoeuvre.
